(19) United States
(12) Patent Application Publication
(10) Pub. No.: US 2025/0122809 A1
(43) Pub. Date: Apr. 17, 2025

(54) GUIDE BLADE ADJUSTING DEVICE AND TURBOMACHINE

(71) Applicant: MAN Energy Solutions SE, Augsburg (DE)

(72) Inventors: Jan KLAUSMANN, Berlin (DE); Hanno WEGNER, Schönefeld /OT Großziethen (DE)

(21) Appl. No.: 18/904,329

(22) Filed: Oct. 2, 2024

(30) Foreign Application Priority Data
Oct. 11, 2023 (DE) 10 2023 127 736.7

(51) Int. Cl. F01D 17/16; F01D 9/04

(52) U.S. Cl. CPC F01D 17/16; F01D 9/04; F05D 2220/32; F05D 2240/12; F05D 2260/60

(57) ABSTRACT

A guide blade adjusting device for a turbomachine, for twisting multiple guide blades about axes of rotation of the guide blades. Each guide blade has a front blade part and a rear blade part which can be twisted relative to one another. A first drive hub, which can be coupled for driving to a first drive motor, having a first control ring, which transmits a twisting of the first drive hub for twisting the front blade parts of the guide blades to the front blade parts. A second drive hub coupled for driving to a second drive motor, and having a second control ring, which transmits a twisting of the second drive hub for twisting the rear blade parts independently of the twisting of the front blade parts of the guide blades to the rear blade parts.

### BACKGROUND OF THE INVENTION

### 1. Field of the Invention

The disclosure relates to a guide blade adjusting device for a turbomachine and to a turbomachine having a guide blade adjusting device.

### 2. Description of Related Art

Turbomachines known from practice have a rotor and a stator. The rotor of a turbomachine includes a shaft and multiple moving blades rotating together with the shaft, wherein the moving blades form at least one moving blade ring. The stator of a turbomachine includes a housing and multiple fixed guide blades, wherein the guide blades form at least one guide blade ring. The guide blades known from practice are embodied in one piece. From practice it is known to adjust the one-piece guide blades of a moving blade ring of a turbomachine via a guide blade adjusting device in such a manner that the guide blades are rotatable about an axis of rotation extending in the radial direction of the rotor.

DE 10 2015 004 649 A1 discloses a guide blade adjusting device for twisting guide blades, which are embodied in two parts. Accordingly, each guide blade comprises a front blade part and a rear blade part, wherein the front blade parts and the rear blade parts can be twisted and thus adjusted jointly via a common control ring. A common drive hub interacts with the common control ring. Starting out from the common drive hub, one of the guide blades of the guide blade ring is directly adjustable, wherein the other guide blades of the guide blade ring, emanating from the drive hub, are indirectly adjustable via the common control ring.

According to DE 10 2015 004 649 A1, the two blade parts of each moving blade, as a consequence of the coupled relocation of the same, can only be twisted and thus adjusted on the basis of a fixed adjusting rule dependent on the coupling mechanism. It is not possible to adjust the front blade part and the rear blade part independently of one another. Thus, the efficiency of a turbomachine can also be increased only to a limited extent.

### SUMMARY OF THE INVENTION

One aspect of the invention is based on a new type of guide blade adjusting device and a turbomachine having such a guide blade adjusting device.

The guide blade adjusting device according to one aspect of the invention, comprises a first drive hub, which can be coupled to a first drive motor and driven via the first drive motor, and a first control ring, which for twisting the front blade parts of the guide blades of the guide blade ring transmits a twisting of the first drive hub to the front blade parts.

Further, the guide blade adjusting device according to one aspect of the invention comprises a second drive hub, which can be coupled to a second drive motor and which can be driven via the second drive motor, and a second control ring, which for twisting the rear blade parts independently of the twisting of the front blade parts of the guide blades of the guide blade ring, transmits a twisting of the second drive hub to the rear blade parts.

In the guide blade adjusting device according to one aspect of the invention, two separate drive hubs are employed, wherein each of the two separate drive hubs can be coupled to a drive motor each. Further, the guide blade adjusting device according to one aspect of the invention has two separate control rings. The front blade parts of the guide blades are adjustable via the first drive motor, the first drive hub and the first control ring. The rear blade parts are adjustable via the second drive motor, the second drive hub and the second adjusting ring independently of the twisting of the front blade parts, namely independently of the front blade parts of the guide blades.

Accordingly, the two blade parts can be adjusted independently of one another so that there is no longer a fixed adjusting rule dependent on a coupling mechanism.

Preferentially, the first control ring is arranged on a first axial side of the guide blade ring, which faces the front blade parts of the guide blades, and the second control ring on a second axial side of the guide blade ring, which faces the rear blade parts of the guide blades. This is preferred for a simple, independent relocation of the front blade part and of the rear blade part of the guide blades.

Preferentially, the first drive hub is directly coupled to one of the front blade parts of one of the guide blades of the guide blade ring in such a manner that the front blade parts of this guide blade of the guide blade ring, emanating from the first drive hub, are directly twistable without interposition of the first control ring. The first drive hub is indirectly coupled to the front blade parts of the other guide blades of the guide blade ring in such a manner that the front blade parts of the other guide blades of the guide blade ring, emanating from the first drive hub, are indirectly twistable subject to the interposition of the first control ring.

Preferentially, the second drive hub is directly coupled to one of the rear blade parts of one of the guide blades of the guide blade ring in such a manner that the rear blade part of this guide blade of the guide blade ring, emanating from the second drive hub, is directly twistable without interposition of the second control ring. The second drive hub is indirectly coupled to the rear blade parts of the other guide blades of the guide blade ring in such a manner that the rear blade parts of the other guide blades of the guide blade ring, emanating from the second drive hub, are indirectly twistable subject to the interposition of the second control ring.

Preferentially, the first drive hub is coupled to the first control ring via a first drive lever and the second drive hub to the second control ring via a second drive lever, wherein the first drive hub together with the first drive lever are arranged on a first circumferential position and the second drive hub together with the second drive lever are arranged on a second other circumferential position of the guide blade ring. By way of the drive levers, the actuation on the respective drive hub can be transmitted to the respective control ring.

Preferentially, the first control ring of the guide blade adjusting device is coupled via a first blade lever each to a bearing pin of the front blade part of a respective other indirectly twistable guide blade, wherein the second control ring of the guide blade adjusting device is coupled via a second blade lever each to a bearing pin of the rear blade part of a respective other indirectly twistable guide blade. The transmission of the actuation emanating from the respective drive hub from the respective control ring to the respective other indirectly twistable guide blades of the guide blade ring takes place by way of the respective blade lever of the guide blade adjusting device.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1: is a perspective extract from a turbomachine in a region of a guide blade ring and a guide blade adjusting device for multi-part guide blades of the guide blade ring;

FIG. 2: is a detail of FIG. 1;

FIG. 3: is a cross-section through the detail of FIG. 2 in the region of a first drive hub;

FIG. 4: is an extract of FIG. 1 twisted in the circumferential direction;

FIG. 5: is a detail of FIG. 4;

FIG. 6: is a cross-section through the detail of FIG. 5 in the region of a second drive hub;

FIG. 7: is a detail of the turbomachine;

FIG. 8: is a cross-section through the detail of FIG. 7 in a region of a second blade lever of the guide blade adjusting device; and

FIG. 9: is a cross-section through the detail of FIG. 7 in the region of a first blade lever of the guide blade adjusting device.

### DETAILED DESCRIPTION OF THE PRESENTLY PREFERRED EMBODIMENTS

The fundamental construction of a turbomachine is familiar to the person skilled in the art addressed here. For the sake of completeness it is explained here that a turbomachine includes a rotor with rotor-side moving blades and a stator with stator-side guide blades. The moving blades of the rotor form at least one moving blade ring, wherein the or each moving blade ring rotates together with a shaft of the rotor. The guide blades of the stator form at least one guide blade ring which is connected to a stator-side housing.

The invention relates to a guide blade adjusting device for the guide blades of the stator of a turbomachine and to a turbomachine having at least one such guide blade adjusting device.

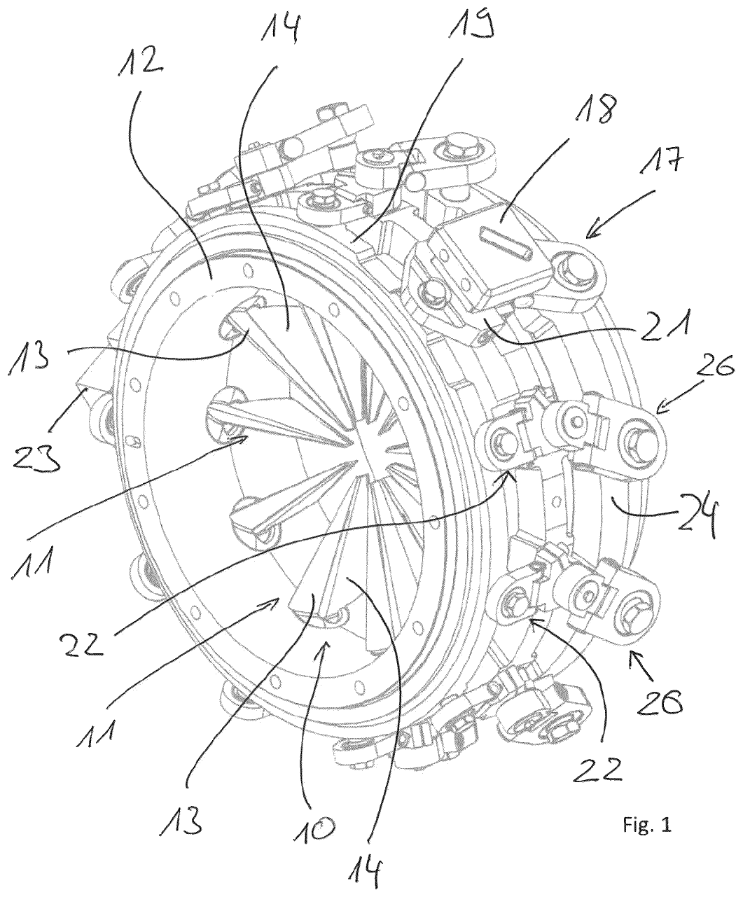

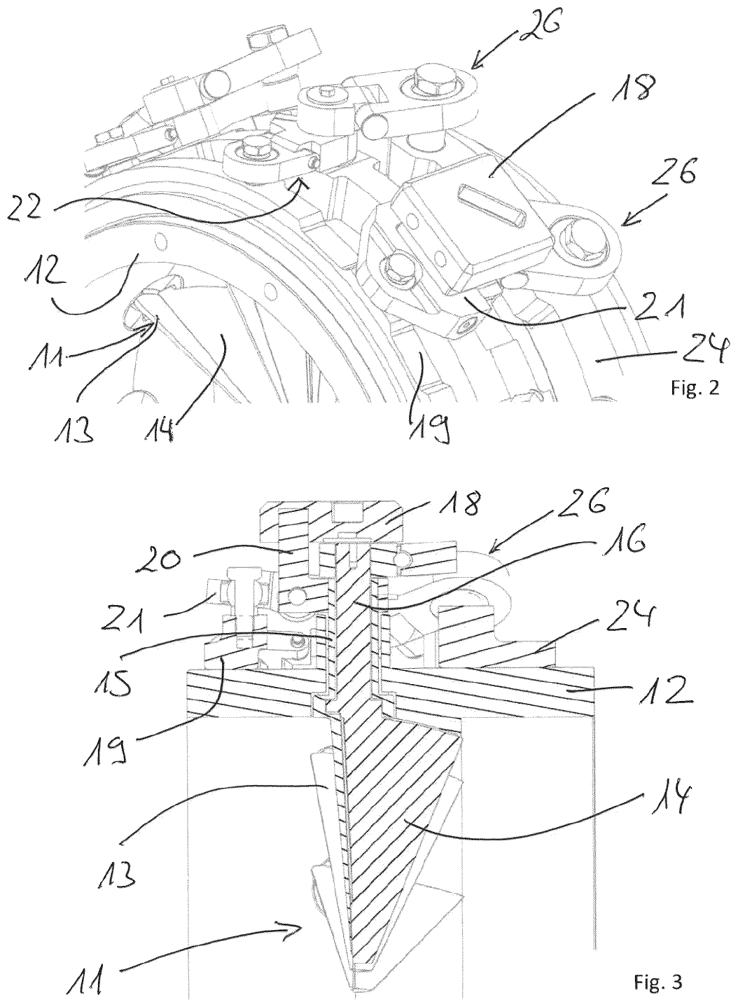

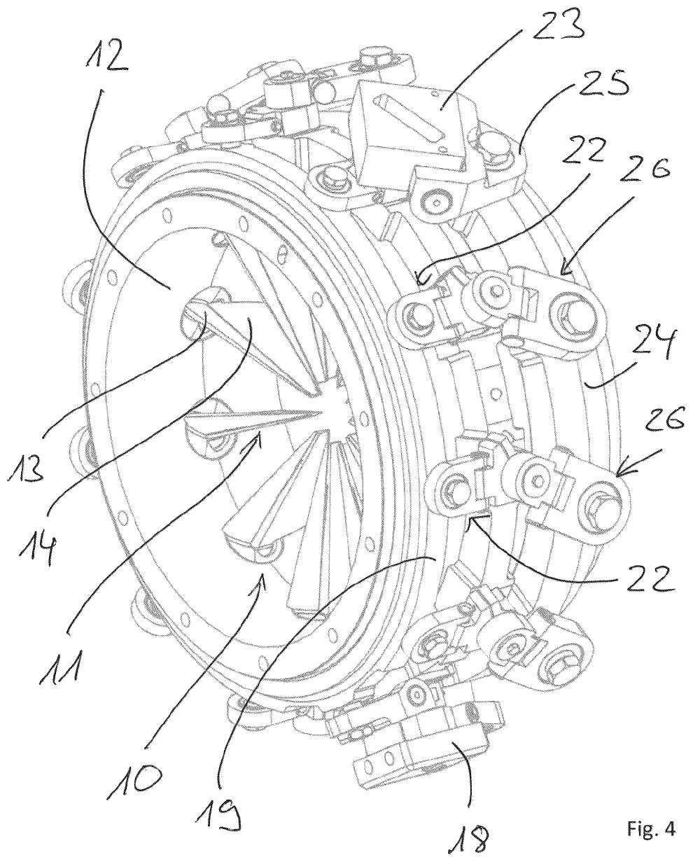

FIG. 1 shows a perspective extract from a turbomachine, namely a perspective view of a so-called inlet guide apparatus of a turbomachine, with the help of which the flow of a process gas prior to entering a rotor can be specifically influenced.

The inlet guide apparatus shown in FIG. 1 has a guide blade ring 10 of multiple guide blades 11, which emanating from a housing 12 define a flow channel, project inwards into the flow channel. Each guide blade 11 is formed of multiple parts of a front blade part 13 and a rear blade part 14. Each of the blade parts 13, 14 of each guide blade 11 has a bearing pin 15, 16, wherein in the shown exemplary embodiment the bearing pin 15 is formed for the front blade part 13 as hollow pin and the bearing pin 16 for the rear blade part 14 as solid pin. The bearing pins 15, 16 of each multi-part guide blade 11 extend coaxially to one another in the radial direction so that accordingly axes of rotation of the bearing pins 15, 16 of the blade parts 13, 14 extending in the radial direction coincide in the region of each guide blade 11. In the region of each guide blade 11, the two blade parts 13, 14 are thus rotatable about a common axis of rotation relative to the housing 12, wherein this axis of rotation extends in the radial direction and is defined by the coaxial axes of the two bearing pins 15, 16.

In order to twist and thus relocate the front and rear blade parts 13, 14 of the guide blades 11, a guide blade adjusting device 17 interacts with the guide blade ring 10.

The guide blade adjusting device 17 comprises a first drive hub 18, which can be coupled to a first drive motor which is not shown and which is drivable via the first drive motor. A first control ring 19, which transmits a twisting of the first drive hub 18 for twisting the front blade parts 13 of the guide blades 11 of the guide blade ring 10 to the front blade parts 13 interacts with this first drive hub 18.

The front drive hub 18 is directly coupled to one of the front blade parts 13 of one of the guide blades 11 of the guide blade ring 10 namely in such a manner that this front blade part 13 of this guide blade 11 of the guide blade ring 10, emanating from the first drive hub 18, is directly twistable without interposition of the control ring 19. Accordingly, FIG. 3 shows that the first drive hub 18, namely an intermediate piece 20 connected to the first drive hub 18, is coupled without interposition of the first control ring 19 to the bearing pin 15 of the front blade part 13 of the guide blade 11 shown there. Accordingly, this guide blade 11, emanating from the first drive hub 18, can be directly twisted and thus relocated.

The first drive hub 18 is indirectly coupled to the front blade parts 13 of the other guide blades 11 of the guide blade ring 10, namely in such a manner that the front blade parts 13 of the other guide blades 11 of the guide blade ring 10, emanating from the first drive hub 18, are indirectly twistable subject to the interposition of the first control ring 19. Thus, the first drive hub 18 is coupled to the first control ring 19 via a first drive lever 21, in order to transmit via the first drive lever 21 an actuation of the first drive hub 18 to the first control ring 19. The first control ring 19 is coupled via a first blade lever 22 each to the bearing pin 15 of the front blade part 13 of a respective other guide blade 11 of the guide blade ring 10 that is indirectly twistable via the first control ring 19.

A twisting of the first drive hub 18 thus causes a direct twisting of the front blade part 13 of a single guide blade 11, likewise a twisting of the first control ring 19 and via the first control ring 19 a twisting of the first blade parts 13 of all other guide blades 11.

The guide blade adjusting device 17, further, comprises a second drive hub 23, which is coupled to a second drive motor which is likewise not shown and which is drivable via the second drive motor. A second control ring 24 interacts with the second drive hub 23. The second control ring 24 transmits a twisting of the second drive hub 23 for twisting the rear blade parts 14 independently of the twisting of the front blade parts 13 of the guide blades 11 of the guide blade ring 10 to the rear blade parts 14 of the guide blades 11.

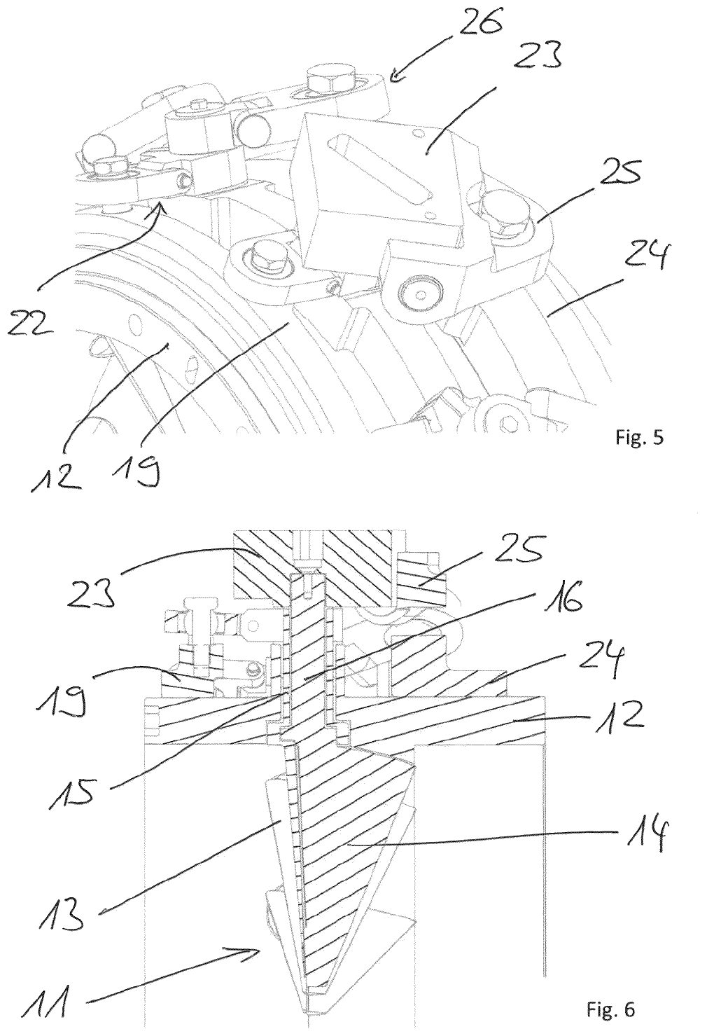

Analogously to the first drive hub 18, the second drive ring 19 is directly coupled to one of the rear blade parts 14 of one of the guide blades 11 of the guide blade ring 10, namely in such a manner that the rear blade part 14 of this guide blade 11, emanating from the second drive hub 23, is directly twistable without interposition of the second control ring 24. Thus, FIG. 5 shows that the second drive hub 23 directly acts on the bearing pin 16 of the rear blade part 14 of the guide blade 11 shown in FIG. 5. The second drive hub 23 is indirectly coupled to the rear blade parts 14 of the other guide blades 11 of the guide blade ring 10, namely in such a manner that the rear blade parts 14 of the other guide blades 11 of the guide blade ring 10, emanating from the second drive hub 23, are indirectly twistable subject to the interposition of the second control ring 24. For this purpose, the second drive hub 23 is coupled to the second control ring 24 via a second drive lever 25, so that a twisting of the second drive hub 23 causes a twisting of the second control ring 24. The second control ring 24 is then coupled, via a second blade lever 26 each, to a respective bearing pin 16 of the rear blade part 14 of a respective other guide blade 11.

The actuation or twisting of the second drive hub 23 accordingly causes the direct twisting of a rear blade part 14 of a single guide blade 11. The twisting of the other rear blade parts 14 of the other guide blades 11 takes place subject to the interposition of the second control ring 24.

As can be best seen from FIGS. 6 to 8, each of the first blade levers 22 is composed of two lever portions 22a, 22b and each of the second blade levers 26 of two lever portions 26a, 26b.

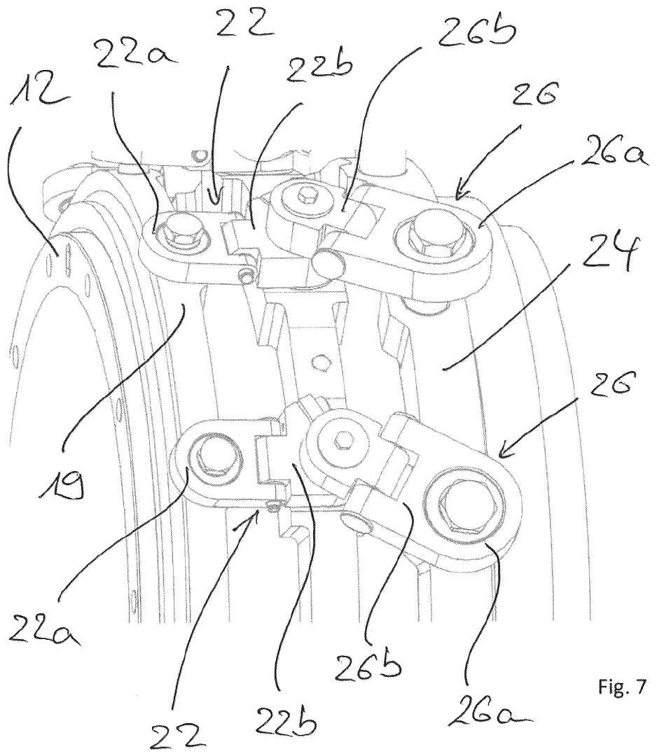

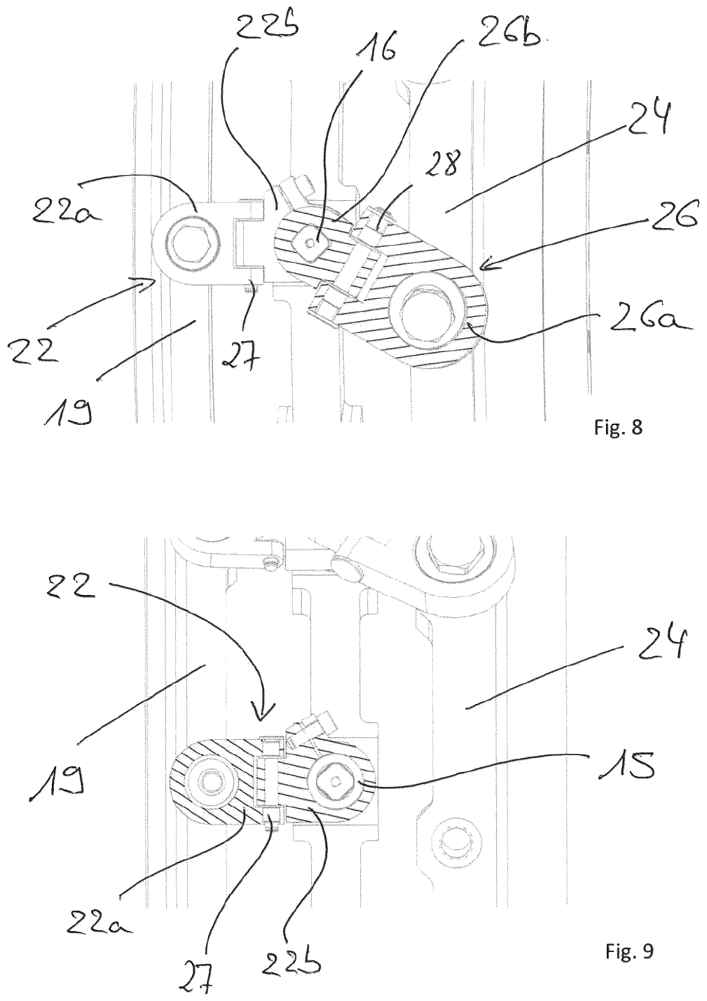

A first of these lever portions, namely the first lever portions 22a, 26a, of each blade lever 22, 26 acts on the respective control ring 19, 24. A second of these lever portions, namely the second lever portions 22b, 26b of each blade lever 22, 26 acts on the respective bearing pin 16, 15. The respective first lever portions 22a, 26a act in an articulated manner on the respective second lever portion 22b, 26b of the respective blade lever 22, 26. FIG. 7 shows the fixed or non-articulated coupling of the second lever portion 26b of a second blade lever 26 to the bearing pin 16 of a rear blade part 14. FIG. 8 shows the fixed or non-articulated coupling of the second lever portion 22b of a first blade lever 22 to the bearing pin 15 of a front blade part 13 of a guide blade 11. Further, FIG. 7, 8 show joints 27, 28 between the first lever portions 22a, 26a and the respective second lever portion 22b, 26b of the respective blade lever 22. The first lever portions 22a, 26a of the blade levers 22, 26 act preferentially in an articulated manner on the respective control ring 19, 24.

The first drive hub 18, together with the first drive lever 21, is arranged in a first circumferential position of the guide blade ring 10 and thus the guide blade adjusting device 17, the second drive hub 23 with the second drive lever 25 is arranged in a second different circumferential position.

Seen in the axial direction of the guide blade ring 10, the first control ring 19 is arranged on a first axial side of the guide blade ring 10, which faces the front blade parts 13, and the second control ring 24 on a second axial side of the guide blade ring 10, which faces the rear blade parts 14 of the guide blades 11.

The guide blade adjusting device 17 according to the invention for adjusting multi-part guide blades 11, which each comprise a front blade part 13 and a rear blade part 14, accordingly utilises two drive hubs 18, 23 and two control rings 19, 24. The front blade parts 13 can be twisted independently of the rear blade parts 14. Between the adjusting of the front blade parts 13 and the rear blade parts 14 there is consequently no fixed adjusting law predetermined by a coupling mechanism. The adjustment between the blade parts 13, 14 can rather be selected freely via the individual actuation of the adjustment emanating from the separate drive hubs 18, 19 via the separate control rings 19, 24.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A guide blade adjusting device for a turbomachine configured to twist multiple guide blades grouped into a guide blade ring about axes of rotation of the guide blades of the guide blade ring extending in a radial direction, wherein each guide blade comprises a front blade part and a rear blade part each of which can be twisted relative to one another, comprising:
a first drive hub coupled to a first drive motor and configured to be driven via the first drive motor;
a first control ring, which transmits a twisting of the first drive hub for twisting the front blade parts of the guide blades of the guide blade ring to the front blade parts;
a second drive hub coupled to a second drive motor and configured to be driven via the second drive motor; and
a second control ring, which transmits a twisting of the second drive hub for twisting the rear blade parts independently of the twisting of the front blade parts of the guide blades of the guide blade ring to the rear blade parts.

2. The guide blade adjusting device according to claim 1,
wherein the first drive hub is directly coupled to one of the front blade parts of one of the guide blades of the guide blade ring such that the front blade part of this guide blade of the guide blade ring, emanating from the first drive hub, can be directly twisted without interposition of the first control ring, and
wherein the first drive hub is indirectly coupled to the front blade parts of other guide blades of the guide blade ring such that the front blade parts of the other guide blades of the guide blade ring, emanating from the first drive hub, are indirectly twistable subject to the interposition of the first control ring.

3. The guide blade adjusting device according to claim 1,
wherein the second drive hub is directly coupled to one of the rear blade parts of one of the guide blades of the guide blade ring such that the rear blade part of this guide blade of the guide blade ring, emanating from the second drive hub can be directly twisted without interposition of the second control ring, and
wherein the second drive hub is indirectly coupled to the rear blade parts of other guide blades of the guide blade ring such that the rear blade parts of the other guide blades of the guide blade ring, emanating from the second drive hub, are indirectly twistable subject to the interposition of the second control ring.

4. The guide blade adjusting device according to claim 1,
wherein the first control ring is coupled via a first blade lever each to a bearing pin of the front blade part of a respective other guide blade, and
wherein the second control ring is coupled via a second blade lever each to a bearing pin of the rear blade part of a respective other guide blade.

5. The guide blade adjusting device according to claim 4,
wherein in a region of each guide blade one of the bearing pins of front and rear blade part (13, 14) is formed as solid pin and the other of the bearing pins of front and rear blade part (13, 14) is formed as hollow pin, the axes of rotation of which extend coaxially in the radial direction.

6. The guide blade adjusting device according to claim 4,
wherein the respective first blade lever and the respective second blade lever comprise two lever portions configured as a lever portion acting on the respective bearing pin of the respective blade part and a lever portion acting on the respective control ring, and
wherein the two lever portions of the respective blade lever are interconnected in an articulated manner.

7. The guide blade adjusting device according to claim 1
wherein the first drive hub is coupled to the first control ring via a first drive lever, and
wherein the second drive hub is coupled to the second control ring via a second drive lever.

8. The guide blade adjusting device according to claim 7,
wherein the first drive hub together with the first drive lever, are arranged in a first circumferential position and the second drive hub together with the second drive lever are arranged in a second other circumferential position of the guide blade ring.

9. The guide blade adjusting device according to claim 1,
wherein the first control ring is arranged on a first axial side of the guide blade ring, which faces the front blade parts of the guide blades, and the second control ring is arranged on a second axial side of the guide blade ring, which faces the rear blade parts of the guide blades.

10. A turbomachine, comprising:
a rotor comprising moving blades;
a stator comprising guide blades, wherein the guide blades form at least one guide blade ring; and
a guide blade adjusting device configured to adjust at least the guide blades of at least one guide blade ring, comprising:
a first drive hub coupled to a first drive motor and configured to be driven via the first drive motor;
a first control ring, which transmits a twisting of the first drive hub for twisting front blade parts of the guide blades of the guide blade ring to the front blade parts;
a second drive hub coupled to a second drive motor and configured to be driven via the second drive motor; and
a second control ring, which transmits a twisting of the second drive hub for twisting rear blade parts independently of the twisting of the front blade parts of the guide blades of the guide blade ring to the rear blade parts.
